(19) United States
(12) Patent Application Publication
(10) Pub. No.: US 2016/0198741 A1
(43) Pub. Date: Jul. 14, 2016

(54) PROCESS FOR EXTRUSION COOKING A KIBBLE

(71) Applicant: Mars, Incorporated, McLean, VA (US)

(72) Inventors: Maria Dolores Martinez-Serna Villagran, Mason, OH (US); Isoken Omosefe Airen, Springdale, OH (US); Joan Helen Mooney, Reading, OH (US); Gregory William Duritsch, West Harrison, IN (US); William Christopher Schildknecht, Cincinnati, OH (US)

(73) Assignee: Mars, Incorporated, McLean, VA (US)

(21) Appl. No.: 15/078,000

(22) Filed: Mar. 23, 2016

Related U.S. Application Data
(62) Division of application No. 13/898,552, filed on May 21, 2013.
(60) Provisional application No. 61/650,400, filed on May 22, 2012.
(60) Provisional application No. 61/649,871, filed on May 21, 2012.

(51) Int. Cl. A23K 40/25; A23K 20/163; A23K 50/42

(52) U.S. Cl. CPC A23K 40/25; A23K 50/42; A23K 20/163

(57) ABSTRACT

Formulation choices and/or process parameters can be used to modify the texture of extrusion cooked food products. Interactions between formulation choices and process parameters may be used in concert to produce extrusion cooked food products of low density and low hardness. Low density and low harness may make the kibble texture easier or more pleasant to chew or swallow.

### CROSS REFERENCE TO RELATED APPLICATIONS

This application is a divisional of U.S. patent application Ser. No. 13/898,552, filed on May 21, 2013 (pending), which, in turn, claims the benefit of U.S. Provisional Patent Application Ser. No. 61/650,400, filed on May 22, 2012, and U.S. Provisional Patent Application Ser. No. 61/649,871, filed May 21, 2012, all of which are incorporated herein by reference.

### FIELD OF THE INVENTION

This invention relates generally to food compositions, more particularly to food compositions produced by extrusion cooking, further to extruded pet food compositions, sometimes referred to as pet food kibble.

### BACKGROUND OF THE INVENTION

Many food products, including pet foods and treats, are produced by extrusion cooking. Generally speaking, the extrusion process involves forming a dough and extruding the dough through a die under high temperature and pressure. The extruded product may be cut or separated into smaller pieces, which may be referred to as puffs or kibble. The extruded product may be allowed to dry or actively dried, as by the addition of heat. Food products formed in this manner may have relatively low moisture content, such as less than 15% water by weight.

Depending on the dough ingredients, extruded foods may have different texture properties, such as airiness, crispiness, hardness, etc. However, extruded foods as a group, and particularly extruded foods having a very low moisture content, may be or be perceived as, hard to chew, hard to swallow, or uncomfortably dry.

One way to address these challenges is to provide soft, wet foods, such as canned food products. However, wet foods may have shorter shelf life before and/or after opening a container; may have a lower nutrient density than dry foods; and may be messier to handle, serve, or eat than dry foods. Another way to address these challenges is to provide semi-soft kibble, which may include plasticizers and/or relatively high moisture content to make the kibble easier to deform at low force (such as chewing), relative to dry kibble. However, semi-soft kibble may also have a lower nutrient density than dry foods. Yet another way to address these challenges is to serve dry foods with a gravy or sauce, either prepared separately or formed by the addition of water or another liquid to the food before serving the food. However, these toppings complicate the preparation of the food, may have a shorter shelf life than the dry food, and/or may be messier to serve or eat than dry food.

There remains a need for a dry kibble which is easy to bite, easy to chew, easy to swallow, and/or has high nutritional value.

### SUMMARY OF THE INVENTION

In some aspects, this disclosure relates to a dough for producing an extruded food product. The dough may comprise at least 4% of a type C starch. The dough may comprise at least 20% native protein sources, as a weight percent of protein content of the dough. The dough may comprise a viscosity-increasing agent. The dough may comprise less than 3% free fats. The dough may comprise between 1% and 5% a source of reducing sugars.

In some aspects, this disclosure relates to a process for cooking a dough for producing an extruded food product. The process may comprise pre-conditioning the dough. The process may comprise extrusion cooking the dough. The dough may have a 19-35% moisture content during pre-conditioning. The dough may be extrusion cooked to form a kibble. The kibble may be dried to a moisture level less than 8% following extrusion. The kibble may be dried to a moisture level less than 5%. The kibble may be dried under heat. The SME applied to the dough during extrusion cooking may be between 15 and 35 Wh/kg.

In some aspects, this disclosure relates to a process for extrusion cooking a kibble having a gelatinized starch matrix. The process may comprise providing or forming a dough. The dough may comprise at least 4% type C starch. The process may comprise pre-conditioning the dough. The dough may be pre-conditioned at a moisture level of 19-35%. The process may comprise extruding the dough. The dough may be extruded at a moisture content of 19-35%. The process may comprise drying the extruded dough to form a kibble. The kibble may be dried to a moisture content less than 10%. The SME during extrusion may between 15 and 40 Wh/kg. The kibble may be dried under heat. The kibble may be dried to a moisture level between 1% and 8%. The kibble may be dried to a moisture level between 1% and 5%. The dough may comprise less than 3% free fats.

In some aspects, this disclosure relates to an extruded kibble comprising a gelatinized starch matrix. The kibble may have a density from 245 to 350 g/L. The kibble may have a hardness from 3 to 8 kgf/cm.sup.2. The kibble may have a porosity greater than about 70%. The gelatinized starch matrix may include at least 4% type C starch. The gelatinized starch matrix may include corn or corn meal.

In some aspects, this disclosure relates to a dough for producing an extruded food product. The dough may comprise at least 4% of a type C starch. The dough may comprise at least 20% native protein sources, as a weight percent of protein content of the dough. At least 25% of the native protein source may be an animal protein. The animal protein may be produced by cooking the protein in boiling water. The animal protein may be produced by drying the animal protein to a temperature not higher than 100.6.degree. C. The animal protein may be produced by grinding the protein. At least 20% of the native proteins may be derived from animal sources and have a peak viscosity greater than 1000 cps.

In some aspects, this disclosure relates to a process for extrusion cooking a kibble. The kibble may have a gelatinized starch matrix. The process may comprise providing or forming a dough. The dough may comprise protein. At least 20% of the protein may be native. The process may comprise pre-conditioning the dough. The dough may be pre-conditioned at a moisture level of 19-35%. The process may comprise extruding the dough. The process may comprise drying the extruded dough to form a kibble. The kibble may have a moisture content less than 10%.

In some aspects, this disclosure relates to a process for extrusion cooking a kibble. The kibble may have a gelatinized starch matrix. The process may comprise providing or forming a dough. At least 20% of the protein may be native. The process may comprise pre-conditioning the dough. The dough may be pre-conditioned at a moisture level of 19-35%. The process may comprise extruding the dough. The dough may be extruded at an SME between 15 and 40 Wh/kg. The process may comprise drying the extruded dough to form a kibble. The kibble may have a moisture content less than 10%. The dough may comprise at least 4% of a type C starch.

In some aspects, this disclosure relates to a kibble. The kibble may have a density from 245 to 350 g/L. The kibble may have a hardness from 3 to 8 kgf/cm.sup.2. The kibble may be produced by a process. The process may comprise providing or forming a dough. The dough may comprise 21-33% protein. The process may comprise pre-conditioning the dough. The dough may be pre-conditioned at a moisture level of 19-35%. The process may comprise extruding the dough. The dough may be extruded at an SME between 15 and 40 Wh/kg. The process may comprise drying the extruded dough to form a kibble. The kibble may have a moisture content less than 10%.

### BRIEF DESCRIPTION OF THE DRAWINGS

FIG. 1 is a graph of hardness vs. moisture content for three exemplary embodiments of the kibble disclosed herein and a conventional kibble.

FIG. 2 is an image showing the porosity of a conventional kibble.

FIG. 3 is an image showing the porosity of an exemplary kibble according to the present disclosure.

FIG. 4 is a profile of viscosity at different temperatures for exemplary chicken meals comprising native proteins.

FIG. 5 is a profile of viscosity at different temperatures for exemplary chicken meals comprising denatured proteins.

### DETAILED DESCRIPTION OF THE INVENTION

As used herein, “kibble” or “dry kibble” refers to an extruded food product with a moisture level less than or equal to 15%, by weight of the food product. “Semi-moist” refers to a food product with a moisture level between 15% and 50%, by weight of the food product. “Wet” refers to a food product having a moisture content equal to or greater than 50%, by weight of the food. Semi-moist or wet foods may be prepared at least in part using extrusion cooking, or may be prepared entirely by other methods. “Non-extruded” refers to a food product prepared by any method other than extrusion cooking, such as frying, baking, broiling, grilling, pressure cooking, boiling, ohmic heating, steaming, and the like.

As used herein, “food product” refers to any composition intended for oral ingestion, and excludes items which are capable of being swallowed but are generally considered inedible, such as rocks or toys made of inedible polymers like PVC, modified PVC, or vinyl, whether swallowed whole or broken and swallowed in pieces.

As used herein, “easy to chew” refers to product hardness, which is the maximum pressure recorded before a kibble breaks or falls apart. When comparing two or more products, the product which breaks at the lowest pressure is considered the easiest to chew.

As used herein, “glycemic index” refers to a measure of the effect of a food or food ingredient on blood sugar (glucose) and insulin levels. The index is relative to the effect of consuming pure glucose. Under different circumstances, it may be desirable to provide a high glycemic index food product, a low glycemic index food product, or a food product having a mix of high and low glycemic index ingredients.

As used herein, “Aw” or “water activity” is a measure of the free or unassociated water in a product, and is measured by dividing the vapor pressure of water in the headspace above a product or composition by the vapor pressure of pure (distilled) water at room temperature (22.degree. C.+−.2.degree. C.). Pure distilled water has an Aw of one.

As used herein, “pet” means dogs, cats, and/or other domesticated animals of like nutritional needs to a dog or a cat. For example, other domesticated animals of like nutritional needs to a cat may include minks and ferrets, who can survive indefinitely and healthily on a nutritional composition designed to meet the nutritional needs of cats. It will be appreciated by one of skill in the art that dogs and cats have nutritional needs which differ in key aspects. At a fundamental level, dogs are omnivores, whereas cats are obligate carnivores. Further, nutritional needs are not necessarily consistent with phylogenetic or other non-nutritional classifications.

As used herein, “complete and nutritionally balanced” refers to a composition that provides all of a typical animal's nutritional needs, excepting water, when fed according to feeding guidelines for that composition, or according to common usage, if no feeding guidelines are provided. Such nutritional needs are described, for example, in Nutrient Profiles for dogs and cats published by the Association of American Feed Control Officials (AAFCO).

As used herein, “native” refers to a protein in a tertiary or quaternary structure. “Native” specifically excludes proteins which have been reduced to a primary structure or to polypeptide moieties.

As used herein, unless otherwise stated for a particular parameter, the term “about” refers to a range that encompasses an industry-acceptable range for inherent variability in analyses or process controls, including sampling error. Consistent with the Model Guidance of AAFCO, inherent variability is not meant to encompass variation associated with sloppy work or deficient procedures, but, rather, to address the inherent variation associated even with good practices and techniques.

Unless otherwise described, all percentages are weight percent of the composition on a dry matter basis.

As discussed above, dry kibble may present advantages over other processed food forms. For example, dry kibble may have a longer shelf life or greater nutrient density, and may be easier to serve, store, or handle than semi-moist or wet foods. However, dry kibble may also be harder to chew or swallow because of the texture of the kibble. In some aspects, this disclosure relates to formulations for a dry kibble which may enable the creation of textures which are easier to chew. In some aspects, the formulations maintain acceptable nutritional content and enable more desirable textures. In other aspects, this disclosure relates to processes for making a dry kibble with a more desirable texture. In some embodiments, the processes can be used to produce dry kibble with improved texture and acceptable nutritional content. In some aspects, this disclosure is related to a kibble which is superior to conventional kibble in texture or nutritional content.

### Kibble Formulation

Extrusion cooking may employ a starch ingredient which is mixed with water prior to extrusion, as in a pre-conditioning cylinder or vessel. When the starch-containing dough is forced through an extruder at high temperature and pressure, the starch gelatinizes and expands, forming a “puff” or “kibble” as the dough comes through the extruder die, the kibble being somewhat less dense than the dough prior to extrusion. Different food formulations expand to widely variant degrees based on a number of factors. One factor is the kind of starch in the formulation. Three different classes of starches may be relevant to kibble texture. Type B starches include those derived from potato and other tubers, beets, tapioca, yucca, and the like, and combinations thereof. Type B starches have a low density crystalline structure and expand relatively quickly and efficiently in response to hydration. Type A starches include those derived from corn (including corn meal), grain, wheat, rice, and the like, and combinations thereof. Type A starches have tightly packed crystalline structures. Because it is harder for moisture to penetrate Type A starches at the molecular level, they generally do not expand as quickly or as much as Type B starches, under similar conditions of temperature, pressure, and moisture level. Type C starches are sometimes described as “high amylose” starches. Type C starches include those derived from peas, chick peas, lentils, black graham bean, other pulse starches, and combinations thereof, and have a mix of crystalline phases, with parts of the structure resembling Type A starches, and parts of the structure resembling Type B starches. Under similar conditions of temperature, pressure, and moisture level, Type C starches will typically swell less or absorb less water (or swell or absorb water less quickly) than Type B or Type A starches.

Extruded food products, and particularly extruded food products which are designed to provide all or a substantial proportion of the nutritional requirements of an animal, typically include Type A starches because these starches are associated with foods that provide a combination of good palatability and good nutritional content. For example, corn generally tastes good and provides a variety of vitamins and nutrients important to good health, including a relatively large amount of carbohydrate.

Type B starches generally have a higher glycemic index than Type A starches. For example, a baked russet potato has a glycemic index of 85.+−.12, while white rice has a glycemic index of 64.+−.7, and brown rice has a glycemic index of 55.+−.5. The higher glycemic index of the Type B starches might not be problematic in foods designed to help maintain or restore blood glucose levels during or after periods of intense or prolonged activity, such as power bars or dog food designed for sporting or working dogs. However, the higher glycemic index of the Type B starches can be problematic for animals that are more sedentary, making it difficult to manage energy levels, blood glucose levels, and/or blood insulin levels throughout the day. The higher glycemic index may be particularly problematic for older or infirm animals, whose ability to manage abrupt changes in blood chemistry may be impaired relative to younger or healthier animals. For example, it may be desirable to use low glycemic index ingredients when formulating a dog food for senior dogs, such as dogs 7 years of age or older, or “super senior” dogs, such as dogs 11 years of age or older.

Type C starches generally have a lower glycemic index than Type A starches, and, under certain processing conditions, can provide some advantages for texture formation relative to Type A starches. However, the incremental improvement in expansion, under conventional processing conditions, when substituting Type C starches for Type A starches is generally modest, particularly for low levels of substitution, such as substituting Type C starch for 10% or less of the Type A starch in a kibble. It is believed that this is because of the relatively high amylose content generally associated with Type C starch sources. Amylose has a tightly packed crystalline structure, and inhibits the expansion of Type C starches. That is, substitution of Type C starches for Type A starches may provide modest improvements in texture, and substitution of Type C starches for Type B starches may give noticeable improvements in glycemic index.

Kibble dough may comprise a protein source. Inexpensive protein sources may include processed protein sources, such as animal digests. Chicken, pork, beef, or lamb by-product meals may be useful in processed foods because they are inexpensive sources of animal protein. These by-product meals are typically produced using processes involving high heat, such as nominal temperatures over 100.degree. C., and shear forces that disrupt the native structure of the protein molecules. For example, by-products may be rendered at temperatures about or greater than 120.degree. C. or even 175.degree. C. At these temperatures, any fat in the material being processed will essentially fry the material being rendered, leading to a relatively crispy product. When ground, as is typical for by-product meal, the crispy texture creates high shear. The combination of the high temperature and the shear denatures a substantial portion of the proteins in the rendered meal. However, to manage the texture of the kibble, it may be desirable to use protein sources that have significantly preserved native, tertiary or quaternary protein structures.

Native vegetable proteins may be useful and examples include proteins from peas or pea flour, soy protein concentrates, lentils, quinoa, garbanzos, amaranth, corn (including corn gluten meal), other grains having a protein content greater than 10% by weight (not on a dry matter basis), and combinations thereof. Other exemplary sources of native proteins may include animal meats or animal meals, eggs, dairy proteins such as whey protein concentrate or isolates, and combinations thereof. Suitable animal meals may be produced at nominal temperatures equal to or lower than 100.degree. C., such as boiling. When the by-product or meal is recovered at these lower temperatures, the material is not fried in its own fat, and the “softer” or less crispy material experiences lower shear during grinding, helping to preserve more native protein structure compared to traditional rendering processes. Suitable sources of native proteins may be processed without exposure to temperatures of 120.degree. C. or higher, proteases or other enzymatic treatment to disrupt or digest enzymes, high shear processes, extraction or separation with chemicals such as hexane that will disrupt protein structure, extreme pH conditions, and combinations thereof. One of skill in the art will recognize that different kinds of protein can tolerate different pH ranges and that different pH ranges may be tolerated under different environmental conditions, such as temperature. However, as a general rule, processes employing pH values less than (more acidic than) 3 or greater than (more alkaline than) 7 may be problematic for maintaining native animal protein structure. Animal proteins will vary in the degree of partial denaturation experienced prior to incorporating them into a dough.

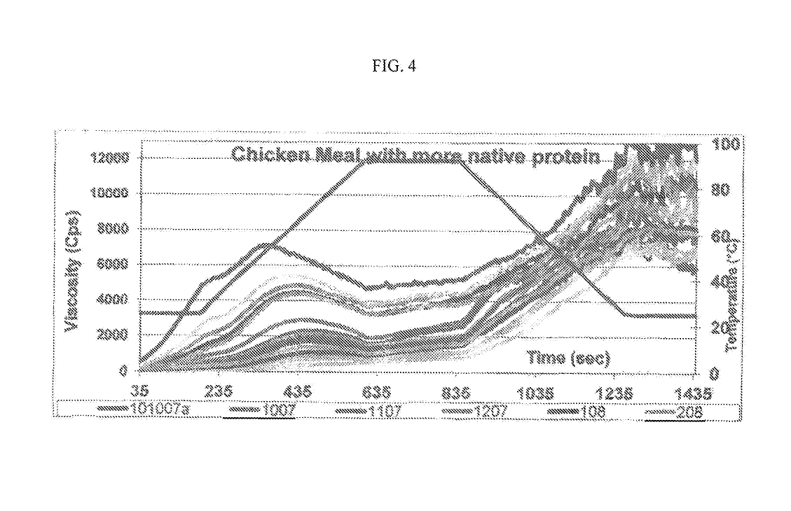

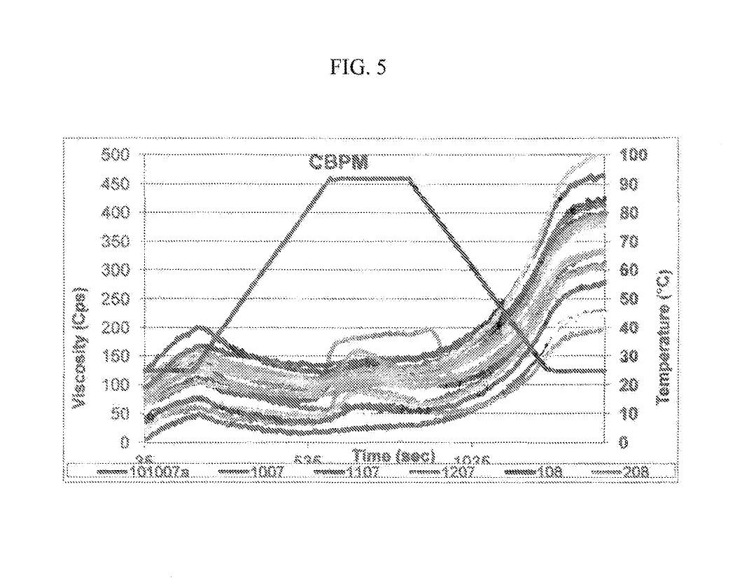

If desired, the extent of denaturation can be assessed by evaluating changes in paste viscosity, water absorption index, or gel strength. For example, chicken meals can be characterized by measuring the peak viscosity and final viscosity of the meal. Meals containing relatively high levels of native proteins will have higher viscosity values (compared to meals containing lower levels of native proteins) when subjected to higher temperatures. Thus, the viscosity profile while heating and cooling a chicken meal can be used to differentiate chicken meals based on native protein content. As shown in FIG. 4, Chicken meals with a higher level of native protein (lower level of denaturation) may have a peak viscosity of 1000 to 6000 cps and a final viscosity of 3000 to 9000 cps. In contrast, as shown in FIG. 5, chicken meals, such as rendered chicken by-product meal with a lower level of native protein (higher level of denaturation) may have a peak viscosity from 100 to 300 cps and a final viscosity from 100 to 300 cps. Put differently, there is less change over the viscosity profile of the denatured proteins, because they are no longer “functional” in response to temperature changes. In FIGS. 4 and 5, the individual profile for any one sample is not necessarily important—what is important is the shape of the curve for products of the same type (e.g., native or denatured).

Without wishing to be bound by theory, it is currently believed that the native protein structures unfold and “stretch” during dough formation, which permits the formation of non-covalent and di-sulfide bonds between neighboring chains, trapping water to form bubbles in a foam-like structure. During extrusion cooking and/or drying, the water in the bubbles evaporates, leaving pores in the dried kibble which contribute to a light, airy texture. In addition, the native proteins may contribute to higher dough viscosity, greater absorption or adsorption of moisture into the dough (thereby facilitating greater hydration of the starches in the dough), and/or serve as “stretchy” binders in the dough, permitting the dough to expand to a greater degree during extrusion than if the proteins were largely denatured prior to dough formation. This results in lower bulk density products with a high expansion ratio (the diameter of the extruded kibble divided by the diameter of the die). Denatured proteins may be less “stretchy” or less physically reactive to changes in temperature, and therefore less prompt to expand. The impact of using relatively low amounts of native proteins, such as less than 20% by weight of the proteins in the dough, may, in isolation, give a modest improvement in texture. However, higher levels of native proteins or the use of native proteins in combination with the use of Type A or Type B starches, and/or in combination with the processing techniques described below, may provide noticeable or even radical changes in texture.

In some embodiments, a dough for making an extruded food product comprising at least 4%, or at least 15%, or about 16% type C starch. The dough may comprise less than 50%, or less than 40%, or less than 30% type C starch. A kibble made from the dough may have similar percentages of type C starch. In some embodiments the dough or kibble may comprise Type A starch, but substantially no corn (including corn meal, corn gluten meal, or other products derived from corn). For example, the dough or kibble may comprise less than 3% corn, or even less than 1% corn. In some embodiments, the dough or kibble may contain corn or corn derivatives, such as corn gluten meal, or may comprise corn or corn derivatives in substantial amounts, such as 3% or more.

In some embodiments, a dough for making an extruded food product comprises at least 50% native protein sources, or at least 20% native protein sources, as a weight percent of protein content of the dough. The native protein sources may comprise less than 90%, or less than 80%, or less than 60%, of the protein content of the dough. Protein content may be estimated using nitrogen content of the dough, as is commonly practiced in the art. The dough may comprise at least 15% native protein sources by dry weight of the composition. The dough may comprise less than 80%, or less than 60%, or less than 50%, native protein sources by dry weight of the composition. A kibble made from the dough may have similar percentages of native protein sources, by protein content or by weight of the composition.

In some embodiments, at least 20%, or at least 30%, or at least 40% of the protein content of the dough may be animal-derived. The remainder of the protein may be derived from vegetable or microbial sources. In some embodiments, at least 20%, or at least 30%, or at least 40% of the native protein content of the dough may be animal-derived. The remainder of the protein may be derived from vegetable or microbial sources. Animal proteins may be, or may be perceived to be, more nutritionally useful to an animal than vegetable or microbial proteins, particularly, but not exclusively, in a diet for a carnivore. In some embodiments, at least 20%, or at least 30%, or at least 40% of the protein content of the dough may be vegetable-derived. The remainder of the protein may be derived from animal or microbial sources. In some embodiments, at least 20%, or at least 30%, or at least 40% of the native protein content of the dough may be vegetable-derived. The remainder may be derived from animal or microbial sources. Vegetable proteins may be, or may be perceived to be, more environmentally friendly or more humane than animal proteins, particularly, but not exclusively, in a diet for an omnivore.

In some embodiments, the dough may have substantially no free or added fats. That is, the dough may include fats from raw materials such as meat or meat by-products, but may have less than about 2.5% free fats, such as fish oils, vegetable oils, animal fat, fat-based palatants, or other fats, or less than about 2% free fats, or less than about 1% free fats. Without wishing to be bound by theory, it is believed that free fats may serve as a lubricant and reduce the efficacy of the specific mechanical energy applied to the dough during processing (as described in greater detail below). Of course, it is possible to include higher levels of free fats, however, other process parameters may need to be adjusted to achieve comparable texture effects in the dried kibble. Additional fats may also be added after extrusion, as by surface coating a fat-based or fat-containing coating onto the kibble. It is possible to reach conventional fat levels for pet foods, such as at least 9%, or at least 14%, or up to 20%, without adding substantial amounts of free fat to the dough. For example, it may be possible to select incoming raw materials with higher inclusion levels of fats, and/or to apply supplemental fats to the coated kibble.

The dough or kibble may further comprise a viscosity-increasing agent, such as xanthan or other gums (as derived from a natural source, chemically modified, or fully synthetic), carboxymethylcellulose (CMC), pectins, agar, gelatin, and combinations thereof, at up to 1% of the dry weight of the composition. The viscosity-increasing agent may be present in any suitable amount, such as at least 0.01%, or at least 0.1%, or at least 0.2% by dry weight of the composition. The purpose of the viscosity-increasing agent will be explained further in the context of exemplary processing conditions, as described below. Typically, it will not be necessary to add more than 1% of a viscosity-increasing agent to the dough. The effect of different viscosity-increasing agents can be measured by their effect in increasing specific mechanical energy (SME) during extrusion. The formulation and process parameters may be mutually modified until the desired SME is achieved.

In some embodiments, the dough or kibble may comprise a humectant or plasticizer. Humectants or plasticizers, such as glycerin, are often used in soft or semi-moist foods, and can give foods, including extruded kibble, a more resilient, chewy texture. In some dry kibble, such as kibble dried to less than or equal to 5% moisture content, the effectiveness of humectants or plasticizers in decreasing the hardness of the food may diminish, because at moisture levels below 5%, the humectant or plasticizer may also be dewatered. However, the presence of relatively high levels of reducing sugars, such as dextrose and fructose, may be helpful as plasticizers to prevent dry kibble from breaking up into fines during handling and shipping. Exemplary reducing sugar sources include carrot powder, corn syrup solids, molasses, tomato powder, fruit juices, dried fruits, pumpkin, sweet potato powder, other tubers high in reducing sugars, and combinations thereof. Suitable sources of reducing sugars may contain 20-50 weight percent reducing sugars, on a dry matter basis. If used, a source of high reducing sugars may be present in the kibble or dough at between 1.5 and 10%, or between 2% and 5% of the composition. Reducing sugars, generally, may be present in the kibble or dough at between 0.75% and 5% of the composition.

The dough or kibble may comprise 10-70 weight percent protein on a dry matter basis, more preferably 20-50 weight percent protein on a dry matter basis. In some embodiments, the dough or kibble may preferably comprise 27-33 weight percent protein on a dry matter basis. The kibble may be complete and nutritionally balanced. The kibble may be a complete and nutritionally balanced diet for a pet, or may be an additive to a complete and nutritionally balanced diet for a pet (such as one of several different kinds of kibbles included as a pre-mixed commercial diet that is, as mixed, complete and nutritionally balanced).

The dough or kibble may comprise any number of other additives as desired, such as vitamins and minerals, oils, fatty acids, amino acids, calorie restriction mimetics, palatants, colorants, preservatives, prebiotics, supplemental fiber, probiotics, bacteriophages, medications, herbs, botanicals, and the like, or combinations thereof.

### Dough Processing and Extrusion

Extrusion cooking processes often include a conditioning step prior to the actual extrusion cooking step. A dough or the ingredients for a dough may be mixed in a conditioner with steam and/or water under controlled conditions to pre-cook or pre-heat the dough, to mix all ingredients into the dough, and/or to prepare the dough (as by hydration) for the desired conditions during extrusion cooking. Generally, some minimum level of hydration, which is dependent upon the dough formulation and extrusion cooking parameters, is needed for the dough to expand during extrusion cooking. Conventional wisdom is that this moisture level should be held as low as possible to minimize the amount of drying required after extrusion cooking. Even if the kibble is dried under ambient conditions, a high moisture level at the cooking step will require additional holding time before the kibble is fully dried and ready for packaging. Of course, if the kibble is dried under heat and/or vacuum, a high moisture level at the cooking step will require additional processing time and/or input of energy to complete the drying step. In addition, increasing the water levels prior to or during extrusion reduces the SME during extrusion. In a typical extrusion process for making pet food, for example, the amount of water used during conditioning/extrusion is low to maintain SME high, which increases product expansion and therefore decreases density. However, the product shows a high hardness, too. Further, there are limits on the time and temperature exposure kibble can tolerate following extrusion cooking, with excessive heat drying contributing to dryness (poor palatability or mouth feel when the kibble is eaten), hard texture (kibble may be hard to break or chew), and poor taste or poor aesthetics if the kibble is scorched during drying. For any of these reasons, the moisture content of a pre-extrusion dough is usually maintained at modest levels.

Surprisingly, if the moisture level of the pre-extrusion dough is increased, the increased hydration of the dough may actually enable a softer, easier-to-chew kibble after drying, even when drying to less than 8% moisture, or less than about 5% moisture, or even about 2% moisture. The moisture level is relevant before extrusion cooking (e.g., in a pre-conditioning cylinder or vessel), during extrusion cooking, and after extrusion cooking, as the starches in a dough will continue to gelatinize and swell for some time following extrusion cooking. In some embodiments, it may be useful to maintain the moisture level before and during extrusion cooking in the range of 18-35% water by weight of composition, or 20-22% water by weight of composition, or 23-35% water by weight of composition, with the understanding that the moisture will decline following extrusion cooking, particularly if the kibble is subjected to an active drying step. Water may be actively added to the composition prior to extrusion (e.g., in a pre-conditioning cylinder or vessel), or during extrusion, or both. In addition to the water, steam may be added (e.g., not just steam associated with hot water being added, but steam added predominantly as steam rather than predominantly as water). While it is possible to get low density products at lower moisture levels during extrusion, higher moisture levels during extrusion facilitate the production of kibble that are both low density and low hardness.

It may be desirable for the moisture content of the freshly extruded kibble (just as the kibble exits the extruder die) to be higher than 20%, or between 19% and 35%, or between 25% and 35%, or between 25% and 30%. If the dough is well hydrated during extrusion, water will be trapped in bubbles in the dough. Large bubbles, such as may be formed if using native proteins and/or Type C starches under high moisture process conditions, will not fully flash off during extrusion. Thus, the moisture content of the freshly extruded kibble may be a signal of whether the dough formed the foamy, open-celled structure desired for low density, low hardness foods. Wet bulk density, measured within 5 minutes or less of extrusion, may also be used as a process control or quality check point to assess whether the dough is being effectively hydrated and “foamed.”

Another parameter for extrusion cooking is the Specific Mechanical Energy (SME) applied to the dough as it is forced through a die plate. While all extrusion cooking apparatus apply some amount of SME to the food being cooked, SME may or may not be calculated or monitored during conventional production operations, because it is not typically treated as a key process variable for achieving specific product characteristics. Rather, SME may be adjusted inadvertently or indirectly to control for process speed or throughput. In one typical equipment set-up, a single-screw extruder, the SME can be increased by increasing the screw speed, or by modifying the screw itself, as by increasing the periodicity of the screw. In a single-screw extruder, useful speed screws may range from 350 rpm or 375 rpm to 600 rpm. In other extrusion equipment, mechanisms for modifying the SME will be apparent to those familiar with the equipment. Manipulating the SME may contribute to improved texture in one or all of at least two ways. First, a higher SME may help break up starch granules, allowing amylose to leach from the starch and amylopectin or other molecules from the starch granules to expand more or more rapidly. Second, a higher SME may help thoroughly mix and hydrate the dough in the final moments before it is forced through the die plate, facilitating starch gelatinization and preparing the dough to expand during extrusion. The presence or dominance of one mechanism or the other may vary based on the dough formulation and other process parameters. An intermediate SME may be helpful in achieving a texture that is both low density and low hardness. Higher SMEs may still contribute to a low density texture (if moisture levels are adequate), but may also be associated with higher hardness. Lower SMEs may contribute to a lower hardness texture, but may also be associated with a higher density if moisture is limited. Accordingly, SME and moisture levels can be manipulated to modify density and hardness independently.

In some embodiments, it may be useful to extrude the dough with an SME of at least about 15 Wh/kg, or at least about 20 Wh/kg, or an SME between about 20 or 25 to 30 or 33 Wh/kg. In one exemplary embodiment, a dough is extruded at an SME between about 20 to 25 or 30 Wh/kg with increased moisture before extrusion (e.g., in a pre-extrusion conditioning cylinder or vessel) and no water added during extrusion, resulting in a kibble with a low density and very low hardness, relative to kibble of the same formulation processed under different conditions. In another exemplary embodiment, a dough is extruded at an SME over 30 Wh/kg and increased moisture before extrusion and no water added during extrusion, resulting in a kibble of higher density and lower hardness than a kibble of the same formulation processed under different conditions.

### Post-Extrusion Drying

Kibbles may be dried following extrusion, either by air drying or by active drying (e.g., application of heat or negative air pressure to remove moisture from the kibble). Drying has conventionally been associated with hardening of the product. That is, longer drying times and lower moisture content are associated with increased hardness. This relationship has been taken into consideration when moderating the moisture added to a dough during pre-extrusion processes (dough formation, pre-conditioning) and during extrusion. However, it has surprisingly been found that the curve of hardness vs. dryness is roughly parabolic. That is, extended drying may result in a product that is less hard than a product dried for less time. The curve is more pronounced for kibble that contains a significant amount of native protein and cooked type B or C starch.

Accordingly, it may be desirable to dry a kibble to less than or equal to 8% moisture, or less than or equal to 5% moisture, or about 2% moisture, or about 2% to about 5% moisture, to achieve a softer/less-hard product. The final moisture of the kibble may be greater than or equal to about 1% moisture, or greater than or equal to about 2% moisture.

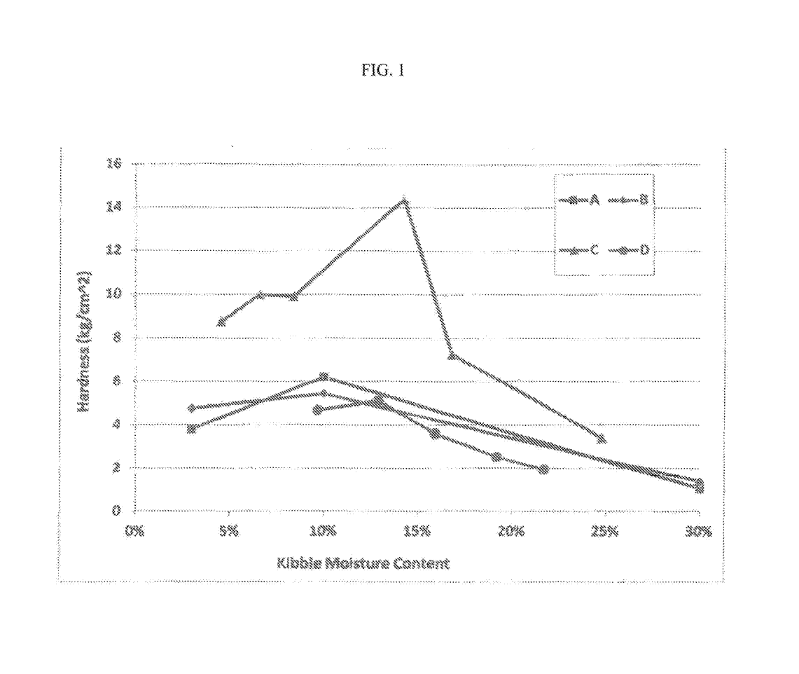

As shown in FIG. 1, hardness may, surprisingly, decline if kibble is dried to very low moisture levels. It may be advantageous to dry a conventional kibble to a moisture content less than about 10%, or even less than about 5%. While the hardness of the kibble increases during initial drying (e.g., from the moisture level of the kibble immediately following extrusion, such as 30% moisture, or 25% moisture), the hardness of the kibble may, surprisingly, decrease if drying is continued until the moisture content is lower than the 6-10% moisture content typical for commercially available dry kibble. It may further be advantageous to dry a kibble having one or more of the formulation modifications described above to a moisture content less than about 10%, or less than about 8%, or even less than about 5%, or to about 2% to about 10% moisture content, or about 2% to about 8% moisture content, or about 2% to about 5% moisture content. Table 1 describes the formulations represented in FIG. 1.

TABLE 1

| | Protein | Carbohydrate | Wet Bulk Density |
|---|---|---|---|
| Code | Sources | Sources | (g/L) |
| A | Chicken, | Oat flour, 16% | 330 |
| | Chicken Meal, | Pea flour, | |
| | Egg | Barley, Sorghum | |
| B | Chicken, Egg | Corn, Barley, | 305 |
| | | Sorghum | |
| C* | Chicken By-Product | Rice, Corn, | 350 |
| | Meal | Sorghum | |
| D | Chicken, | Oat flour, 16% | 280 |
| | Chicken Meal, | Pea flour, | |
| | Egg | Barley, Sorghum | |

*Conventional, commercially-available kibble

### Interactions Between Formulation, Extrusion, and Post-Extrusion Process

While the formulation, extrusion, and post-extrusion details disclosed herein may be useful in isolation, it may be advantageous to use them in combination. For example, to increase SME in the extruder, it may be most efficient if the formulation excludes significant levels of free fats. Without wishing to be bound by theory, it is believed that free fats can lubricate the dough during processing, and reduce the effect of the objective SME input. As another example, high moisture levels before and during extrusion may help gelatinize the starch in the food, thereby increasing expansion and leading to a lower density kibble which can (but does not necessarily) lower the hardness of the kibble. The porosity of the kibble may be different if achieved only by starch gelatinization (tending to high number of pores with small diameter), than by the combination of starch gelatinization and protein unfolding (tending to larger pore sizes and thinner walls between pores). However, high moisture levels before and/or during extrusion may be most effective in lowering the hardness of the kibble if the kibble is dried down to a moisture content less than 8% after extrusion.

As yet another example, drying the kibble to a moisture content less than 8% after extrusion may be more effective if the dough includes native proteins that can make a more elastic dough able to absorb or adsorb steam and air and produce expansion with large, numerous pores in the freshly extruded kibble. Slowly drying the kibble to a low moisture content (e.g., by extending the residence time in the post-extrusion drier) can help retain the foamy porosity of the freshly extruded kibble. It may be advantageous to slowly evaporate the water in the kibble so that the pore walls in the freshly extruded kibble can dry and strengthen before the water fully evaporates. Thus, rather than raising temperature in the drier it may be advantageous to lower temperature and extend residence time in the drier. This is difficult with conventional kibble, which may have smaller pores, requiring higher temperatures to pull water from the center of the kibble during time in the drier. With kibble having larger pores, water can more easily escape the kibble, so the extension of time in the drier is not as extreme as it might seem to be. The total thermal input is roughly the same as conventional drying conditions, but a lower temperature is used for an extended time. One of skill in the art will understand that desirable ranges will vary with a number of parameters, such as process throughput, kibble size, and, as disclosed herein, kibble porosity.

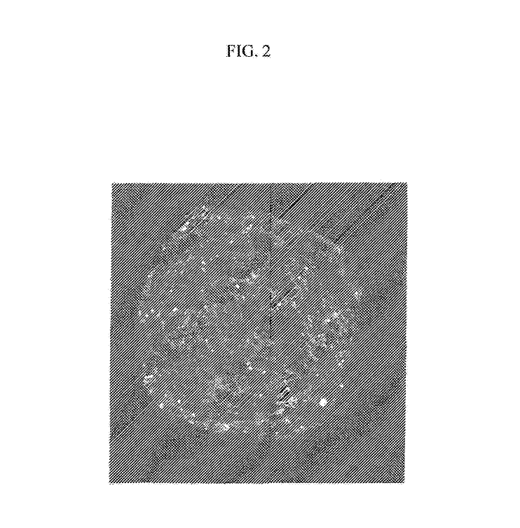

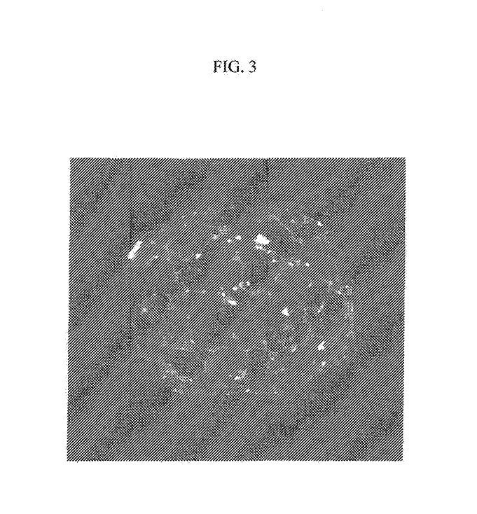

A conventional kibble, for example, may have a density of about 400 g/L and a hardness of about 12 kgf/cm.sup.2 or greater, while a kibble that includes native proteins and is dried to a moisture content less than 5% may have a density of about 245 g/L and a hardness of about 3.4 kgf/cm.sup.2, or a hardness of about 6 kgf/cm.sup.2, or a hardness less than about 8 kgf/cm.sup.2, or a hardness of about 3 to 6 kgf/cm.sup.2 or about 3 to 8 kgf/cm.sup.2. As an alternative measure, a conventional kibble may have a porosity between 33% and 55%, while a kibble that includes native proteins and is dried to a moisture content less than 5% may have a porosity greater than 70%, or even greater than 75%. To reduce the tendency of the kibble to produce fines during shipping and handling, it may be desirable to maintain the kibble porosity below 90%, or below 85%. A conventional kibble having a porosity of 54% and a bulk density of 365 g/L is shown in FIG. 2. In contrast, a kibble as described herein, having a porosity of 79% and a bulk density of 245 g/L is shown in FIG. 3.

It is contemplated that any feature disclosed may be combined with any other feature, either within the formulation, within the process, or as a combination of formulation and process, with the expectation of obtaining at least modest improvements in texture over a formulation and/or process lacking those features. More specifically, different combinations of the formulation characteristics and/or process characteristics described herein may be used to modify texture in new ways, such as independently altering the hardness and density of the dry kibble.

### Kibble Properties

Kibble produced as disclosed above may have unusual properties relative to conventional kibble. For example, kibble produced as disclosed above may have a density from about 245 to about 300 g/L and/or a Hardness from about 3 to about 8 kgf/cm.sup.2. In comparison, conventional kibble may have a density greater than 400 g/L, and a Hardness between about 9 and about 20 kgf/cm.sup.2. Kibble produced as disclosed above may have a porosity greater than 60%, or greater than 70%, or greater than 75%, or between 60% and 75%, or between 70% and 75%.

### Test Methods

### Hardness

The food hardness test is a compressive strain test. Using a calibrated Instron compression tester (or equivalent) with a 1 KN load cell and plate/anvil set-up, place a piece of kibble as flat as possible at the point of testing (this will vary depending on the kibble shape being tested). The anvil is a cylindrical, flat-bottomed test fixture and must be larger in diameter than the kibble being tested. Set up the tester to compress the kibble to 33.33% of its original height. Repeat for at least 25 kibble pieces for each type of kibble tested. Sweep away any debris or residue between samples. Report the maximum load (kgf) pressure (maximum observed load/kibble surface area). The mean maximum pressure is reported for each set of 25 samples. If using an Instron compression tester, the following parameters are used:

Test Parameters
Test rate=6.35 mm/min
Control mode=compressive extension
End of test value 1=33% compressive strain

Compression testing results are reported as maximum load (kgf).

### Bulk Density

Clean and level a calibrated scale with 1-gram or better resolution. Tare the scale using a clean, dry, calibrated 1-Liter cup. Position a funnel having a minimum diameter sufficient to allow the kibble to be tested to flow freely, and a maximum diameter at the same point to channel kibble into the 1-L cup or vessel, approximately 2 inches above the top of the 1-L cup with the bottom (outlet) of the funnel blocked. Gently fill the funnel with slightly more than 1-L of kibble to be tested. With the 1-L cup under the funnel, unblock the funnel and allow the kibble to flow into the 1-L cup. Using a straight-edge (such as a ruler or strike stick), remove excess kibble by sliding the straight-edge smoothly across the top of the 1-L cup. The kibble should not be level with the rim of the 1-L cup. Place the 1-L cup on the tared scale and record the results. The bulk density is the scale reading (in grams) divided by 1-L.

### Porosity

### Scanco System

A Scanco Medical AG (Switzerland) micro-CT system, CT80 serial number 06071200 was used for acquisition of data.

### Sample Selection

The samples were individual kibbles, randomly selected from a small bag of kibble.

### Sample Prep

A custom multi-layer sample tube was used to more easily position the samples for scanning. The custom tube consists of an approximately 35 mm in diameter Scanco tube with a specially designed insert of 4 layers, each layer approximately 16 mm high with an internal diameter of 28 mm, to hold 1 kibble. The sample is placed in the insert, between 2 layers of fine sponge to hold it in place for scanning.

### Image Acquisition Parameters Used in the Scanco CT80

Image acquisition parameters of the 3-D 36 micron isotropic scan include: Medium resolution (500 projections) with the x-ray tube set for a current of 145 .mu.A, 8 watts, and a peak energy of 55 kVp. An Aluminum filter 0.5 mm thick was used. Integration time 400 msecond, Averaging set at 4. A slice increment of 36 microns, with region of interest covering approximately 7-13 mm area with an imaging time of approximately 2.5-4.5 hours, depending on the size of the kibble. The slices were used to reconstruct the CT image in a 1024.times.1024 pixel matrix, with a pixel resolution of 36 micron.

### Image Analysis

Percent porosity is defined as the percent of voxels below a fixed threshold divided by the total number of voxels in the 3D region of interest. The 3D region of interest was manually selected as the largest single, rectangular, 3D volume that would fit entirely within the kibble. Since kibbles are different sizes, the volume of the region of interest varies with each kibble. The threshold used to separate the kibble from the background was 49 on a scale of 0 to 1000. The Scanco scaling factor for reconstruction was 4096. The software measures the percent of voxels above the threshold, which can be converted to percent porosity by subtracting the result from 1.

### Viscosity

### Rheological Properties Using the Rapid Visco Analyzer (RVA)

The rheological properties of dry ingredients (such as chicken meal) are measured using a Rapid Visco Analyzer (RVA) model RVA-4 supplied by Newport Scientific Pty. Ltd. of Warriewood NSW 2102 Australia, or equivalent. The instrument, including moisture content corrections, should be operated in accordance with the manufacturer's instructions (using Standard Profile 1).

The parameters used to characterize components of the present invention are peak viscosity and final viscosity. The average of 3 sample peak viscosity values is considered to be the respective peak viscosity of a material, while the average of 3 sample final viscosity values is considered to be the final viscosity for a material.

### RVA Method for Dry Ingredients:

1. Determine the % moisture (M) of a sample as follows:
a.) Weigh the sample to the nearest 0.01 gram.
b.) Dry the sample in a convection oven at 130.degree. C. for 3 hours.
c.) Immediately after removing the sample from the oven, weight the sample to the nearest 0.01 gram.
d.) Divide the dry weight of the sample by the initial weight of the sample and multiply the result by 100. This is the % moisture for the sample.

2. Calculate sample weight (S) and water weight (W) of the sample using Table 1 titled Weight of Sample and Added Water Corrected for Moisture Content found on page 20 of the RVA—4 Series Instruction Manuel, Issued March 1998.

3. Place the sample into a canister containing an equivalent weight of distilled and deionized water as that of the water weight obtained in Step (2) above and stir the combined sample and distilled and deionized water mixture using the RVA paddle by rotating said paddle 10 times in said mixture.

4. Place the canister into RVA tower and run the Standard Profile (1) which results in a graph of paste viscosity versus time.

5. From the graph of paste viscosity versus time read the maximum viscosity obtained during the heating and holding cycles of the Standard Profile (1). The maximum viscosity is the sample peak viscosity.

6. From the graph of paste viscosity versus time read the viscosity obtained at the end of the test. This is the final viscosity.

### Examples

The following are non-limiting examples demonstrating the effect of different levels or combinations of variables on the hardness and/or density of a dried kibble. Examples 1-23 were produced using a Clextral EV-32 Extruder.

| Example | 1 | 2 | 3 | 4 |
|---|---|---|---|---|
| Protein Source | Chicken, | Chicken, | Chicken, | Chicken, |
| | Chicken Meal, | Chicken Meal, | Chicken Meal, | Chicken Meal, |
| | Egg | Egg | Egg | Egg |
| Carbohydrate | Barley, Rice, | Barley, Rice, | Barley, Rice, | Barley, Rice, |
| Source | Oat Flour, | Oat Flour, | Oat Flour, | Oat Flour, |
| | Potato Flakes | Potato Flakes | Potato Flakes | Potato Flakes |
| | | (5%) | (5%) | (5%) |
| Glycerin (%) | 0 | 0 | 3 | 9 |
| Kibble Density | 303 | 384 | 300 | 310 |
| (g/L) | | | | |
| Kibble Moisture | 1.19 | 1.55 | 0.78 | 0.87 |
| Content (%) | | | | |
| Hardness | 6.5 | 5.2 | 6.5 | 7.8 |
| (kgf/cm²) | | | | |
| Screw Speed | 450 | 300 | 500 | 500 |
| (RMP) | | | | |
| SME (W · h/kg) | 37 | 28 | 36 | 36 |
| Water (%) in | 20 | 20 | 20 | 20 |
| Conditioning | | | | |
| Cylinder | | | | |
| Steam (%) in | 9 | 9 | 9 | 9 |
| Conditioning | | | | |
| Cylinder | | | | |
| Example | 5 | 6 | 7 | 8 |
| Protein Source | Chicken, | Chicken, | Chicken, | Chicken, |
| | Chicken Meal, | Chicken Meal, | Chicken Meal, | Chicken Meal, |
| | Egg | Whey Protein | Egg | Egg |
| | | (1%), Egg | | |
| Carbohydrate | Barley, Rice, | Barley, Rice, | Barley, Rice, | Barley, Rice, |
| Source | Oat Flour, | Oat Flour, | Oat Flour, | Oat Flour |
| | Potato Flakes | Potato Flakes | Potato Flakes | |
| | (5%), Tomato | (5%) | (5%) | |
| | Powder (5%) | | | |
| Glycerin (%) | 0 | 0 | 0 | 0 |
| Kibble Density | 319 | 346 | 355 | 342 |
| (g/L) | | | | |
| Kibble Moisture | 3.72 | 2.99 | 4.02 | 2.92 |
| Content (%) | | | | |
| Hardness | 4.8 | 7.0 | 7.9 | 6.7 |
| (kgf/cm²) | | | | |
| Screw Speed | 380 | 380 | 380 | 380 |
| (RMP) | | | | |
| SME (W · h/kg) | 28 | 22 | 21 | 20 |
| Water (%) in | 20 | 20 | 20 | 20 |
| Conditioning | | | | |
| Cylinder | | | | |
| Steam (%) in | 9 | 9 | 9 | 9 |
| Conditioning | | | | |
| Cylinder | | | | |
| Example | 9 | 10 | 11 | 12 |
| Protein Source | Chicken, | Chicken, | Chicken By- | Chicken, |
| | Chicken Meal, | Chicken Meal, | Product Meal | Chicken Meal, |
| | Egg | Egg | | Egg |
| Carbohydrate | Barley, Rice, | Barley, Rice, | Rice, | Barley, Rice, |
| Source | Oat Flour, | Oat Flour, | Corn, | Oat Flour, |
| | Potato Flakes | Potato Flakes | Sorghum | Potato Flakes |
| | | (5%) | | (5%) |
| Glycerin (%) | 3 | 3 | 0 | 0 |
| Kibble Density | 345 | 323 | 398 | 349 |
| (g/L) | | | | |
| Kibble Moisture | 3.24 | 3.40 | 5.61 | 5.89 |
| Content (%) | | | | |
| Hardness | 4.1 | 4.2 | 6.9 | 7.6 |
| (kgf/cm²) | | | | |
| Screw Speed | 380 | 380 | 380 | 400 |
| (RMP) | | | | |
| SME (W · h/kg) | 17 | 21 | 28 | 32 |
| Water (%) in | 20 | 20 | 20 | 20 |
| Conditioning | | | | |
| Cylinder | | | | |
| Steam (%) in | 9 | 9 | 9 | 9 |
| Conditioning | | | | |
| Cylinder | | | | |

| Example | 13 | 14 | 15 | 16 |
|---|---|---|---|---|
| Protein Source | Chicken, | Chicken, | Chicken, | Chicken, |
| | Chicken Meal, | Chicken Meal, | Chicken Meal, | Chicken Meal, |
| | Egg | Whey Protein, | Egg | Egg |
| | | Egg | | |
| Carbohydrate | Barley, Rice, | Barley, Rice, | Pea flour (16%), | Oat flour, |
| Source | Oat Flour, | Oat Flour, | Potato flour | Pea flour (16%), |
| | Potato Flakes | Potato Flakes | (5%), oat flour, | Barley, Sorghum |
| | (5%) | (5%) | barley, sorghum | |
| Glycerin (%) | 9 | 0 | 0 | 0 |
| Kibble Density | 363 | 350 | 280 | 308 |
| (g/L) | | | | |
| Kibble Moisture | 6.86 | 6.38 | 2.29 | 2.66 |
| Content (%) | | | | |
| Hardness | 11 | 4.6 | 7.5 | 4.1 |
| (kgf/cm²) | | | | |
| Screw Speed | 600 | 380 | 500 | 500 |
| (RMP) | | | | |
| SME (W · h/kg) | 38 | 28 | 35 | 26 |
| Water (%) in | 20 | 16 | 18 | 20 |
| Conditioning | | | | |
| Cylinder | | | | |
| Steam (%) in | 9 | 9 | 9 | 9 |
| Conditioning | | | | |
| Cylinder | | | | |

| Example | 17 | 18 | 19 | 20 |
|---|---|---|---|---|
| Protein Source | Chicken, | Chicken, | Chicken, | Chicken, |
| | Chicken Meal, | Chicken Meal, | Chicken Meal, | Chicken Meal, |
| | Egg | Egg | Egg | Egg |
| Carbohydrate | Oat flour, | Potato flour | Potato flour | Potato flour |
| Source | Pea flour (16%), | (5%), oat flour, | (5%), Oat flour, | (5%), Oat flour, |
| | Barley, Sorghum | Pea flour (16%), | Pea flour (16%), | Pea flour (4%), |
| | | Barley, Sorghum | Barley, Sorghum | Barley, Sorghum |
| Glycerin (%) | 0 | 0 | 0 | 0 |
| Kibble Density | 300 | 305 | 280 | 290 |
| (g/L) | | | | |
| Kibble Moisture | 3.30 | 2.58 | 1.75 | 1.38 |
| Content (%) | | | | |
| Hardness | 4.6 | 4.2 | 7.5 | 7.9 |
| (kgf/cm²) | | | | |
| Screw Speed | 500 | 500 | 500 | 500 |
| (RMP) | | | | |
| SME (W · h/kg) | 30 | 30 | 35 | 38 |
| Water (%) in | 10 | 18 | 18 | 18 |
| Conditioning | | | | |
| Cylinder | | | | |
| Steam (%) in | 9 | 9 | 9 | 9 |
| Conditioning | | | | |
| Cylinder | | | | |

| Example | 21 |
|---|---|
| Protein Source | Chicken, Egg |
| Carbohydrate | Corn, Barley, |
| Source | |
| Glycerin (%) | 0 |
| Kibble Density | 285 |
| (g/L) | |
| Kibble Moisture | 1.68 |
| Content (%) | |
| Hardness | 8.1 |
| (kgf/cm²) | |
| Screw Speed | 500 |
| (RMP) | |
| SME (W · h/kg) | 37 |
| Water (%) in | 18 |
| Conditioning | |
| Cylinder | |
| Steam (%) in | 9 |
| Conditioning | |
| Cylinder | |

### Elaboration of Examples +, ++, +++, and ++++

These tables present the ingredients in the formula that provide protein to the formula. Other ingredients are present in the formula but do not provide a significant protein contribution.

| | | | | |
|---|---|---|---|---|
| Examples | 13 | 1, 2 | 16, 17 | 15, 19 |

Percent Ingredient Total in the Formula
Animal Ingredients

| | | | | |
|---|---|---|---|---|
| Egg Product | 4.53 | 4.09 | 4.04 | 4.05 |
| Chicken Meal 066 (native) | 10.32 | 19.86 | 21.09 | 21.26 |
| Chicken Meal 183 (denatured) | 3.08 | 2.05 | 5.05 | 5.06 |
| Chicken Meal (native) | 13.95 | 9.21 | 4.27 | 3.93 |

Vegetable Ingredients

| | | | | |
|---|---|---|---|---|
| Barley Flour | 9.06 | 8.18 | 13.04 | 12.21 |
| Sorghum Grain | 0.00 | 0.00 | 13.04 | 12.21 |
| Oat Flour | 16.09 | 19.84 | 13.04 | 9.07 |
| Pea Flour | 0.00 | 0.00 | 13.05 | 12.22 |
| Potato Flour | 4.53 | 4.09 | 0.00 | 4.05 |
| Rice, Brewers | 16.09 | 19.84 | 0.00 | 0.00 |

Other Ingredients

| | | | | |
|---|---|---|---|---|
| Beet Pulp | 2.72 | 3.27 | 3.23 | 3.24 |
| Fish Meal | 6.34 | 6.55 | 6.47 | 6.48 |
| Flax | 0.14 | 0.12 | 0.12 | 0.12 |
| Carnitine BM | 0.00 | 0.00 | 0.10 | 0.10 |
| Vit E BM | 0.12 | 0.11 | 0.11 | 0.11 |
| CBP Flavor | 0.00 | 0.00 | 0.00 | 0.40 |
| Tomato | 0.00 | 0.00 | 0.00 | 2.02 |
| 336 Palatant | 1.09 | 0.98 | 0.97 | 0.97 |

Protein Contributions
(%, based on Guaranteed Analysis)
Animal Ingredients

| | | | | |
|---|---|---|---|---|
| Egg Product | 8.81 | 8.81 | 8.76 | 8.76 |
| Chicken Meal 066 (Native) | 4.73 | 10.08 | 10.83 | 10.90 |
| Chicken Meal 183 (Denatured) | 8.14 | 5.99 | 14.98 | 14.98 |
| Chicken Meal 042 (native) | 39.95 | 29.22 | 13.70 | 12.59 |
| Total Contribution | 61.63 | 54.10 | 48.27 | 47.23 |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for extrusion cooking a kibble having a gelatinized starch matrix, the process comprising:
providing or forming a dough comprising at least 4% type C starch, as a weight percentage of the dough;
pre-conditioning the dough at a moisture level of 19-35%;
extruding the dough at a moisture content of 19-35%; and
drying the extruded dough to form a kibble having a moisture content less than 10%.

2. The process of claim 1, wherein the SME during extrusion is between 15 and 40 W·h/kg.

3. The process of claim 2, wherein the kibble is dried under heat.

4. The process of claim 2, wherein the kibble is dried to moisture level between 1% and 8%.

5. The process of claim 4, wherein the kibble is dried to a moisture level between 1% and 5%.

6. The process of claim 2, wherein the dough comprises less than 3% free fats.
